(19) United States
(12) Patent Application Publication
(10) Pub. No.: US 2012/0058396 A1
(43) Pub. Date: Mar. 8, 2012

(54) OXIDATION-RESISTANT METAL SUPPORTED RECHARGEABLE OXIDE-ION BATTERY CELLS AND METHODS TO PRODUCE THE SAME

(76) Inventors: Chun Lu, Sewickley, PA (US); Kevin Huang, Export, PA (US); James L. Shull, Murrysville, PA (US); Shih-Yu W. Liu, Pittsburgh, PA (US); Harold D. Harter, West Mifflin, PA (US); Shailesh D. Vora, Monroeville, PA (US)

(21) Appl. No.: 12/876,391

(22) Filed: Sep. 7, 2010

(51) Int. Cl. H01M 4/38; H01M 4/02

(52) U.S. Cl. 429/221; 429/209; 429/231.5

(57) ABSTRACT

The invention describes the application of oxidation-resistant metal (preferably, stainless steel) 140 in a metal electrode 200 combination, as a support and current collector for a rechargeable oxide-ion battery cell where the metal electrode 200 consists of a bottom layer 120, and where the oxidation-resistant metal 140 has surfaces preferably coated with protective coating 160. The metal electrode 200 is integrated with oxide-ion conductive electrolyte 220 and air electrode 240 to yield an oxidation-resistant metal supported cell.

### BACKGROUND OF THE INVENTION

1. Field of the Invention

This present invention relates to electrode designs for rechargeable oxide-ion battery (ROB) cells. More specifically, the invention describes the application of oxidation-resistance metal including stainless steel as a support and current collector in a ROB metal electrode for reducing materials cost and improving cell performance.

2. Description of Related Art

Electrical energy storage is crucial for the effective proliferation of an electrical economy and for the implementation of many renewable energy technologies. During the past two decades, the demand for the storage of electrical energy has increased significantly in the areas of portable, transportation, load-leveling and central backup applications. The present electrochemical energy storage systems are simply too costly to penetrate major new markets. Higher performance is required, and environmentally acceptable materials are preferred. Transformational changes in electrical energy storage science and technology are in great demand to allow higher and faster energy storage at lower costs and longer lifetimes necessary for major market enlargement. Most of these changes require new materials and/or innovative concepts, with demonstration of larger redox capacities that react more rapidly and reversibly with cations and/or anions.

Batteries are by far the most common form of storing electrical energy, ranging from: standard every day lead—acid cells, exotic iron-silver batteries for submarines taught by Brown in U.S. Pat. No. 4,078,125, nickel-metal hydride (NiMH) batteries taught by Kitayama in U.S. Pat. No. 6,399,247 B1, metal-air cells taught in U.S. Pat. No. 3,977,901 (Buzzelli), to Isenberg in U.S. Pat. No. 4,054,729, and to the lithium-ion battery taught by Ohata in U.S. Pat. No. 7,396,612 B2. These latter metal-air, nickel-metal hydride and lithium-ion battery cells require liquid electrolyte systems.

Batteries range in size from button cells used in watches, to megawatt load leveling applications. They are, in general, efficient storage devices, with output energy typically exceeding 90% of input energy, except at the highest power densities. Rechargeable batteries have evolved over the years from lead-acid through nickel-cadmium and nickel-metal hydride (NiMH) to lithium-ion batteries. NiMH batteries were the initial workhorse for electronic devices such as computers and cell phones, but they have almost been completely displaced from that market by lithium-ion batteries because of the latter's higher energy storage capacity. Today, NiMH technology is the principal battery used in hybrid electric vehicles, but it is likely to be displaced by the higher power energy and now lower cost lithium batteries, if the latter's safety and lifetime can be improved. Of the advanced batteries, lithium-ion is the dominant power source for most rechargeable electronic devices.

What is needed is a dramatically new electrical energy storage device that can easily discharge and charge a high capacity of energy quickly and reversibly, as needed. What is also needed is a device that can operate for years without major maintenance. What is also needed is a device that does not need to operate on natural gas, hydrocarbon fuel or its reformed by-products such as H_{2.} One possibility is a rechargeable oxide-ion battery (ROB), as set out in application Ser. No. 12/695,386, filed on Jan. 28, 2010.

A ROB comprises a metal electrode, an oxide-ion conductive electrolyte, and a cathode. The metal electrode undergoes reduction-oxidation cycles during charge and discharge processes for energy storage. For example, in discharging mode, the metal is oxidized:

yMe+x/2O₂=Me_{y}Oₓ

and is reduced in charging mode:

Me_{y}Oₓ=x/2O₂+yMe, where Me=metal.

Because the metal redox reactions are accompanied by large volume variation, for instance, if manganese (Mn) metal is used, the volume change associated with reaction of Mn+1/2O₂=MnO is 1.73. In the case of tungsten (W), the volume change is 3.39 when W is totally oxidized to WO₃. Without appropriately designed electrode, such drastic volume variation in practice can lead to spallation of metal electrode and possible failure of a ROB cell. The electrode comprises a structural skeleton, active metal component, and pores. The skeleton is made of single and/or multiple components and is capable of conducting electrical current, and it contains active metal component in its pores. The skeleton maintains structural integrity by accommodating the volume change associated with metal redox reactions in its pores.

The metal electrode must meet the following requirements to be effective in practice. It must be compatible with adjacent components including electrolyte and interconnect during battery fabrication and operation in terms of minimal mismatch in coefficient of thermal expansion and negligible chemical reactions with the electrolyte and interconnect. It must possess adequate electrical conductivity to minimize its Ohmic loss. It must possess sufficient catalytic activity to promote metal redox reaction to reduce polarization losses.

The energy storage capacity in terms of watt hour (Wh) of a ROB cell is ultimately determined by the amount of active metal incorporated into the metal electrode, assuming complete utilization of the active metal. Therefore, the more active metal in the electrode, the larger the storage capacity. Consequently, this is capacity advantage by increasing the thickness of a metal electrode. Producing thicker electrode, on the other hand, requires more skeleton materials and the cost of skeleton must be low for profitable purpose. Also the thick electrode can limit the cell power in watts (W) if the skeleton is incapable of sufficiently conducting electrical current, in other words, the Ohmic resistance of the skeleton is high. Thus, highly electrically conductive and low cost skeleton is needed to attain both high capacity and high power on the per capital basis.

It is a main object of this invention to provide cost effective oxidation-resistance metal as a support and current collector as a metal electrode for a ROB cell.

### SUMMARY OF THE INVENTION

The above need for producing a low-cost, high capacity and high power ROB is supplied and object accomplished by providing oxidation-resistant metal (e.g. stainless steel) as the support in the metal electrode. The oxidation-resistant metal supplies a highly electrically conductive path in the metal electrode so that the Ohmic resistance from the metal electrode will be minimized. Secondly, the oxidation-resistant metal also possesses higher mechanical strength than its ceramic counterparts. As a result, the reliability and cell-production yield can be improved too. More importantly, selected oxidation-resistant metal such as stainless steel is cost effective. The invention broadly comprises a combination of side layers of oxidation-resistant metal, active metal component between the side layers and a bottom layer for producing and consuming oxygen species.

### BRIEF DESCRIPTION OF THE DRAWINGS

For a better understanding of the invention, reference may be made to the preferred embodiments exemplary of this invention, shown in the accompanying drawings in which:

FIG. 1 illustrates the known working principals of a rechargeable oxide-ion battery (ROB) cell;

FIG. 2 is a graph of the estimated normalized Ohmic resistance (R in Ω*cm²) of the metal-electrode skeletons of this invention, as a function of its thickness, where the skeleton is assumed to have 50 vol. % porosity and made of electrically conductive ceramic or stainless steel, respectively; and

FIG. 3 is a schematic illustration of the invented oxidation-resistant metal supported cell.

### DESCRIPTION OF THE PREFERRED EMBODIMENTS

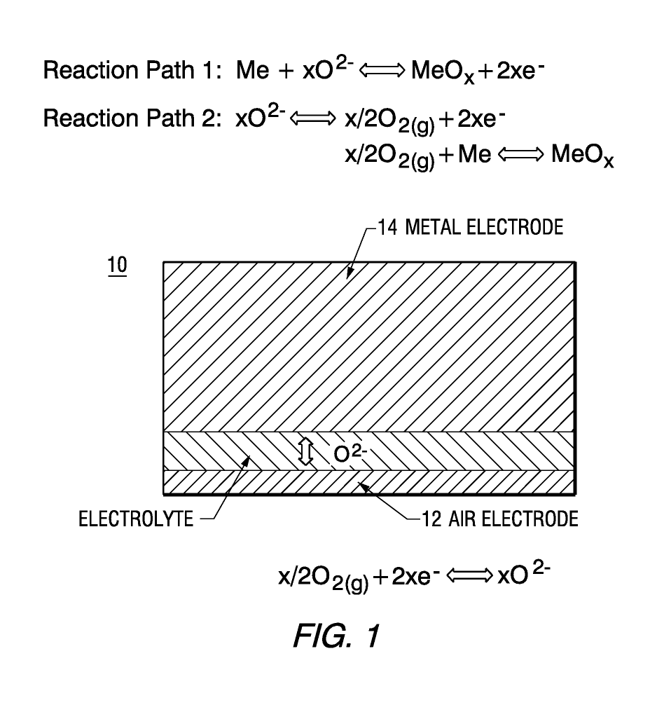

The working principles of a rechargeable oxide-ion battery cell 10 are schematically shown in FIG. 1. In discharge mode, oxide-ion anions migrate from high partial pressure of oxygen side (air electrode—12) to low partial pressure of oxygen side (metal electrode—14) under the driving force of gradient of oxygen chemical potential. There exist two possible reaction mechanisms to oxidize the metal. One of them, solid-state diffusion reaction as designated as Path 1, is that oxide ion can directly electrochemically oxidize metal to fault metal oxide. The other, gas-phase transport reaction designated as Path 2, involves generation and consumption of gaseous phase oxygen. The oxide ion can be initially converted to gaseous oxygen molecule on metal electrode, and then further reacts with metal via solid-gas phase mechanism to form metal oxide. In charge mode, the oxygen species, released by reducing metal oxide to metal via electrochemical Path 1 or solid-gas mechanism Path 2, are transported from metal electrode back to air electrode. To enable the electrochemical reactions listed in FIG. 1, the electrical current must be conducted sufficiently along its path including the metal electrode. Thus, electrically conductive materials must be used to produce the metal electrode. The candidate metal electrode materials for the ROB cell include electrically conductive ceramics such as doped LaCrO₃, doped SrTiO₃, and doped LaVO₃. However, in general their electrical conductivity in a reducing environment (low oxygen partial pressure) is limited, such as ˜5 S/cm in moist 5% H₂-95% N₂ at 800° C.

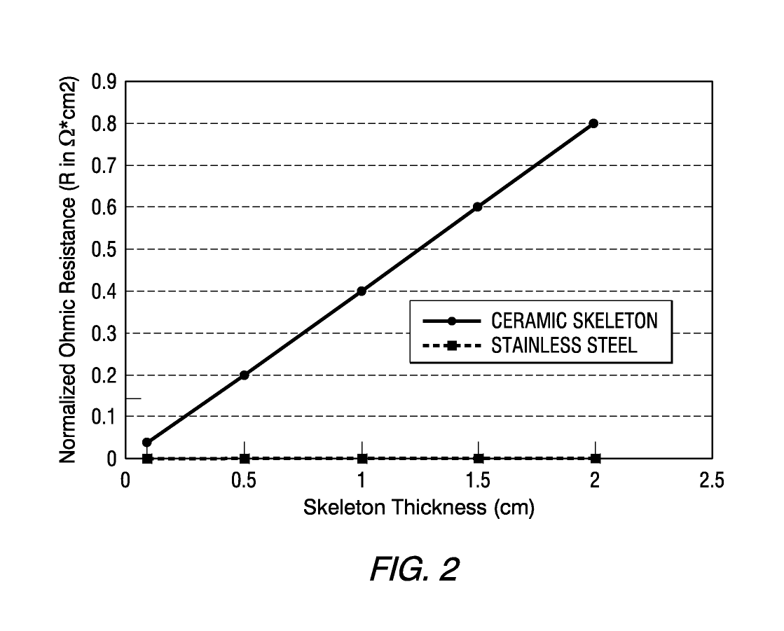

Compared to its ceramic counterpart described above, the stainless steel used in this invention possesses high electrical conductivity, for example ˜9500 S/cm in the same environment. Its higher conductivity makes stainless steel outperform its ceramic counterparts for ROB metal electrode application. For instance, FIG. 2 shows the estimated normalized Ohmic resistance (R in Ω*cm²) of metal-electrode skeletons as a function of thickness. The skeleton is assumed to have 50 vol % porosity and made of electrically conductive ceramic or stainless steel, respectively. R is 0.4 and 0.002 Ω*cm² for a 1 cm thick skeleton made of ceramic and stainless steel, respectively. Clearly, stainless steel is favored for skeleton application.

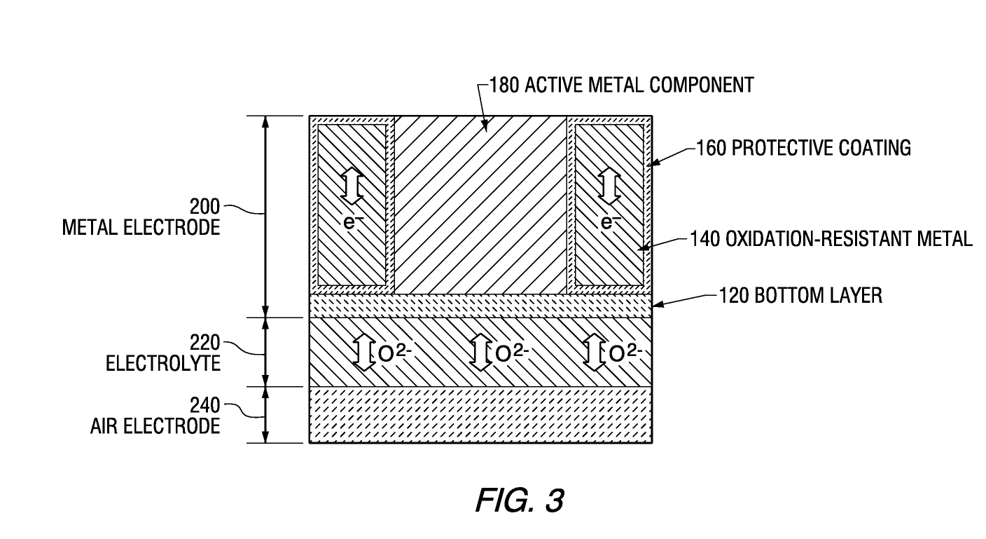

FIG. 3 illustrates the invented oxidation-resistant metal supported cell. The metal electrode 200 consists of a bottom oxygen redox layer 120, side layers of oxidation-resistant metal 140 whose surface can be coated with protective coating 160, and active metal component 180 between the side layers. This active metal component is a solid metal. The metal electrode 200 is integrated with oxide-ion conductive electrolyte 220 next to the oxygen redox layer and exterior air electrode 240 to yield an oxidation-resistance metal supported cell. The oxidation-resistant metal 140 can be selected from noble metal, chromium-based alloys, ferric stainless steel alloys, Fe—Ni—Cr based alloys, other oxidation-resistant alloys, and any of their mixtures. The oxidation-resistant metal has porosity from 20 vol. % to 90 vol. %, more preferably 35 vol. % to 85 vol. %. Its thickness ranges from 10 micrometers to 20 centimeters, preferably from 100 micrometers to 5 centimeters, more preferably 250 micrometers to 2.5 centimeters.

The surface of the oxidation-resistant metal can be preferably modified with a protective coating 160 possessing electronic but negligible oxide-ion conductivity. The protective coating 160 is compromised of noble metal and electronic conductive ceramic including doped LaCrO₃, doped SrTiO₃ , and doped LaVO₃, and any of their mixture, having a thickness from 10 nanometers to 500 micrometers, preferably from 100 nanometers to 100 micrometers, more preferably 1 micrometer to 50 micrometers. The oxygen redox bottom layer 120 is made of composite materials possessing high catalytic activity toward oxygen redox reaction and can possess mixed electronic and ionic conductivity. Exemplary materials include doped CeO₂, stabilized zirconia, doped/updoped LaₓSr₁₋ₓGa_{y}Mg_{1-y}O₃, doped LaCrO₃, doped SrTiO₃, and doped LaVO₃, and any of their mixture. Its thickness ranges from 10 nanometers to 200 micrometers, preferably from 100 nanometers to 100 micrometers, more preferably 5 micrometer to 50 micrometers. Processing techniques can include vapor deposition, thermal spraying, plating and impregnation.

The oxidation-resistant metal 140 can have a planar or closed end tubular geometry or a hybrid of the two. Electrolyte 220 is sandwiched between the bottom oxygen redox layer 120 and an outer air electrode 240.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A metal electrode useful in a rechargeable oxide-ion battery cell comprises side layers of oxidation-resistant metal, an active metal component between the side layers, and a bottom oxygen redox layer.

2. The metal electrode of claim 1, wherein the oxidation-resistant metal is ferric stainless steel.

3. The metal electrode of claim 1, wherein the oxidation resistant metal is selected from the group consisting of noble metal, chromium-based alloys, stainless steel alloys, Fe—Ni—Cr based alloys and mixtures thereof.

4. The metal electrode of claim 1, wherein the oxidation-resistant metal, conducts electrical current through the metal electrode.

5. The metal electrode of claim 1, wherein the oxidation-resistant metal has a porosity ranging from 20 vol. % to 90 vol. %.

6. The metal electrode of claim 1, wherein the oxidation-resistant metal has a thickness from 10 micrometers to 20 centimeters.

7. The metal electrode of claim 1, wherein the active metal component and oxidation-resistant metal are integrated together assuring compatibility during cell fabrication and operation.

8. The metal electrode of claim 1, wherein the oxidation-resistant metal has geometry of planar, tubular, or hybrid of the two.

9. The metal electrode of claim 1, wherein the surface of the oxidation-resistant metal is coated with a protective coating comprising electronic conductors.

10. The metal electrode of claim 9, wherein the protective coating is selected from the group consisting of noble metal, electronically conductive ceramic and mixtures thereof.

11. The metal electrode of claim 9, wherein the protective coating has a thickness from 10 nanometers to 500 micrometers.

12. The metal electrode of claim 1, wherein the bottom layer possesses activity for producing and consuming oxygen species.

13. The metal electrode of claim 1, wherein the bottom layer possesses mixed electronic and ionic conductivity.

14. The metal electrode of claim 1, wherein the thickness of the bottom layer is from 100 nanometers to 3 millimeters and it contacts electrolyte.
